(19) United States
(12) Patent Application Publication
(10) Pub. No.: US 2003/0223924 A1
(43) Pub. Date: Dec. 4, 2003

(54) Gas-pocket distributor and method of distributing gas

(76) Inventors: Robert W. Bachtel, El Cerrito, CA (US); Frederick W. Lam, Oakland, CA (US)

Correspondence Address: Penny L. Prater, ChevronTexaco Corporation, P.O. Box 6006, San Ramon, CA, 94583-0806, US

(21) Appl. No.: 10/158,682

(22) Filed: May 29, 2002

(51) Int. Cl. B01J 8/04; C10G 45/04; C10G 47/02

(52) U.S. Cl. 422/196; 422/220; 422/311; 208/108; 208/213; 208/251 H; 208/254 H

(57) ABSTRACT

A distributor assembly for hydroprocessing a hydrocarbon mixture of hydrogen-containing gas and liquid hydrocarbon is presented. The distributor assembly has a circular plate with a plurality of hollow risers, or tubular zones, bound thereto for distributing hydrogen-containing gas and liquid hydrocarbon through openings in the circular plate member. Each of the hollow risers has a tubular opening in its associated side. At least some of the risers are partially obstructed at their bottom ends, in order to prevent entry of gas bubbles through the bottom of the tube. Side entry into the risers is preferred, since it provides an opportunity for mixing gas and liquid hydrocarbon. The distributor assembly is connected to an internal wall of a reactor. A method is also presented for hydroprocessing a hydrocarbon feed stream comprising flowing a mixture of hydrogen-containing gas and liquid hydrocarbon into a reactor zone to produce evolved hydrogen-containing gas; and flowing the mixture of hydrogen-containing gas and liquid hydrocarbon through a plurality of partially obstructed tubular zones while admixing simultaneously therewith the evolved hydrogen-containing gas.

### FIELD OF THE INVENTION

The present invention relates to a gas-pocket distributor assembly for distributing a mixture of liquid hydrocarbons and hydrogen-containing gas(es) and the hydroprocessing method which employs this assembly.

### BACKGROUND OF THE INVENTION

Hydroprocessing or hydrotreatment to remove undesirable components from hydrocarbon feed streams is a well known method of catalytically treating such heavy hydrocarbons to increase their commercial value. “Heavy” hydrocarbon liquid streams, and particularly reduced crude oils, petroleum residua, tar sand bitumen, shale oil or liquefied coal or reclaimed oil, generally contain product contaminants, such as sulfur, and/or nitrogen, metals and organo-metallic compounds which tend to deactivate catalyst particles during contact by the feed stream and hydrogen under hydroprocessing conditions. Such hydroprocessing conditions are normally in the range of 212° F. to 1200° F. (100° C. to 650° C.), at pressures of from 20 to 300 atmospheres. Generally, such hydroprocessing is in the presence of catalyst containing group VI or VIII metals such as platinum, molybdenum, tungsten, nickel, cobalt, etc., in combination with various other metallic element particles of alumina, silica, magnesia and so forth having a high surface to volume ratio. More specifically, catalyst utilized for hydrodemetallation, hydrodesulfurization, hydrodenitrification, hydrocracking, etc., of heavy oils and the like are generally made up of a carrier or base material; such as alumina, silica, silica-alumina, or possibly, crystalline aluminosilicate, with one or more promoters or catalytically active metal(s) (or compound(s)) plus trace materials. Typical catalytically active metals utilized are cobalt, molybdenum, nickel and tungsten; however, other metals or compounds could be selected dependent on the application.

A particularly effective reactor and method for hydroprocessing a hydrocarbon feed stream is disclosed in U.S. Pat. Nos. 5,885,534 and 5,958,220. That reactor, depicted in attached FIGS. 1-3, comprises a reactor vessel 10 (see FIGS. 1 and 2) having an inlet conduit 14 (see FIGS. 1-2) adapted to introduce into the vessel a premixed stream 34 (FIGS. 1-3) of hydrogen-containing gas 36 (FIGS. 1 and 3) and a liquid hydrocarbon stream 38 (FIGS. 1-3). The vessel 10 contains an aperture support plate 16 (FIG. 1) for supporting thereabove a catalyst bed 18 (FIG. 2). The catalyst bed 18 descends in a “plug flow” manner as the stream of hydrogen-containing gas 36 (FIGS. 1 and 3) and liquid hydrocarbon stream passes upwardly through the catalyst bed. Spent catalyst is removed from the bottom of the bed 18 through a riser 28 (FIGS. 1-3), and fresh catalyst is introduced onto the top of the bed through a riser 19 (FIG. 2). Products of a reaction between the hydrogen gas and the hydrocarbon liquid are removed from the top of the vessel through a central duct 19A (FIG. 2). A screen 19B (FIG. 2) extends across the interior of the vessel at a location above the upper surface of the bed 18 to prevent catalyst from exiting through the duct 19A.

Disposed below the catalyst support 16 (FIG. 1) is a grid-like circular plate 22 (FIGS. 1-3), whereby a plenum chamber 24 is formed between the catalyst support 16 and the plate 22. The plate 22 has a plurality of openings 26 that communicate with a plurality of open-ended risers 28 that depend downwardly from the plate 22. Each riser 28 contains a central bore 29 (FIG. 3) and an opening 30 (FIGS. 1 and 3). The risers 28 conduct the mixture 34 (FIGS. 1-3) of gas and liquid 38 (FIGS. 1-3) to the plenum chamber 24 (FIG. 1). A gas head 50 (FIG. 1) is formed between an underside of the plate 22 and lower ends of the risers 28, the gas head extending to a level below the openings 30 (FIGS. 1 and 3). Thus, hydrogen containing gas 36A (FIGS. 1 and 3) evolves into the head 50 and flows in the direction of arrow M and through the openings 30. The presence of the gas head 50 (FIG. 1) is ensured by a suitable sizing of the openings 30. In the absence of the openings 30 there would be a violent slugging of gas and liquid up the risers 28 at random locations because the liquid height would rapidly vary and expose the bottom ends of different risers 27. Thus, large gas bubbles would reach the bottom of the catalyst support plate 16, rather than a gentle, steady rise of small bubbles.

In order to distribute the hydrogen-containing gas across the interior of the vessel, i.e., to oppose a concentration of the gas at the center of the vessel, a deflector plate 27 (FIG. 2) is disposed over the inlet 14 to deflect the gas bubbles laterally outwardly (see FIG. 2).

However, it has been learned that despite the presence of the deflector 27 (FIG. 2), considerable quantities of hydrogen-containing gas still manage to reach the risers 28 located in the center region of the plate 22, especially the risers located near the outer edge of the deflector 27 from which many gas bubbles exit. That results in excess hydrogen going into the middle of the reactor, depriving other parts of the catalyst bed of sufficient hydrogen to prevent coking.

Therefore, it would be desirable to provide a reactor which results in a more uniform distribution of hydrogen-containing gas through the reactor, in order to minimize the occurrence of coking.

### SUMMARY OF THE INVENTION

One aspect of the present invention relates to a reactor comprising a vessel containing a catalyst bed. A support is disposed within the vessel for supporting the catalyst bed. A plate member is disposed below the support and includes plate openings extending therethrough. The vessel includes an inlet for introducing a mixture of hydrogen-containing gas and hydrocarbon liquid into a bottom header formed beneath the plate. Risers communicate with respective plate openings and extend downwardly therefrom into the bottom header whereby a vapor space is formed in the bottom header between the plate and an upper surface of the mixture disposed in the bottom header. The upper surface of the mixture is disposed above bottom ends of the risers. Each riser includes a side opening disposed within the vapor space for conducting, into the riser, hydrogen-containing gas evolving from the mixture. At least some of the risers are obstructed. Each obstructed riser has a blockage extending across a bottom end thereof for opposing the entry of gas bubbles into those bottom ends. A lateral entrance is provided for each of the obstructed risers for admitting the mixture into the obstructed riser, the lateral entrance disposed beneath the vapor space.

Another aspect of the invention relates to a method for hydroprocessing a desired hydrocarbon feed stream in the reactor previously disclosed, comprising the steps of:

A. conducting a mixture of hydrogen-containing gas and hydrocarbon liquid through a reactor which comprises a vessel supporting a catalyst bed, the vessel having the following features: an inlet, a bottom header, a riser, a support, and a catalyst bed, the vessel further comprising a support below the catalyst bed and a plate member, having openings located below the support; a vapor space being maintained between the plate and an upper surface of the mixture disposed in the bottom header, the upper surface being disposed above the bottom ends of the risers, whereby hydrogen-containing gas evolves from the mixture within the vapor space; and

B. conducting the evolved gas into the risers from the vapor space, through side openings disposed in the risers; the bottom ends of at least some of the risers being obstructed in a manner which constrains the mixture to travel laterally to enter the obstructed risers.

### BRIEF DESCRIPTION OF THE DRAWINGS

FIG. 1 is a partial perspective sectional view of a reactor known in the art.

FIG. 2 is a schematic side view of the reactor shown in FIG. 1.

FIG. 3 is an enlarged sectional view of a riser shown in FIG. 1.

FIG. 4 is a sectional view taken through the lower portion of a reactor and depicting a first embodiment of the present invention.

FIG. 5 is an enlarged sectional view through a riser of FIG. 4, depicting the first embodiment of the invention.

FIG. 6 is a view, similar to FIG. 5, depicting a second embodiment of the invention.

FIG. 7 is a view, similar to FIG. 5, depicting a third embodiment of the invention.

### DETAILED DESCRIPTION OF PREFERRED EMBODIMENTS OF THE INVENTION

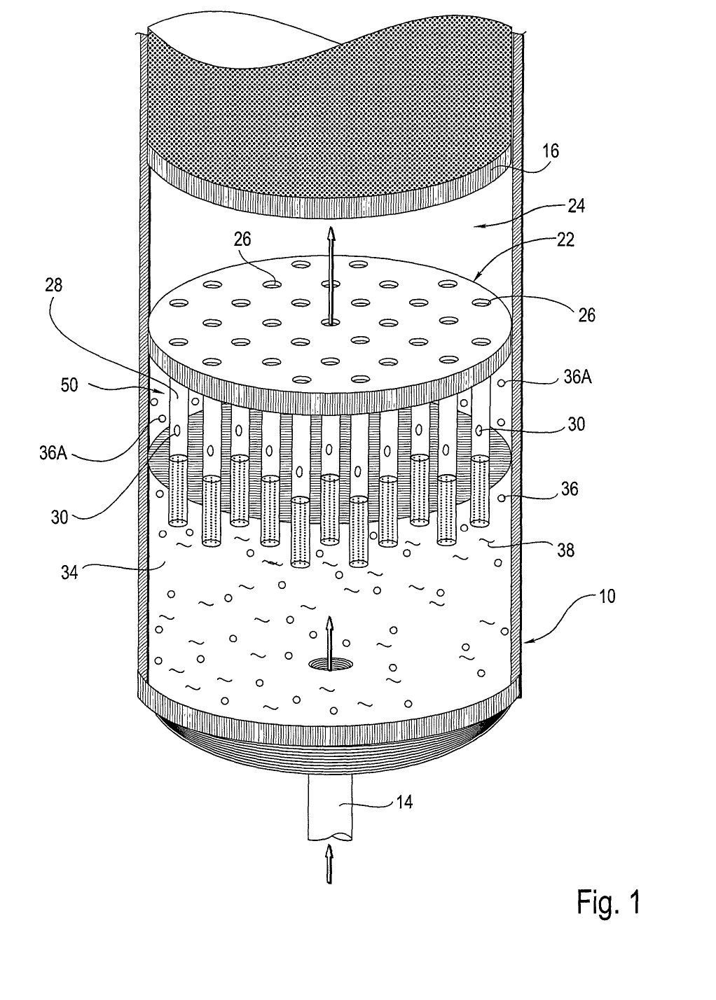

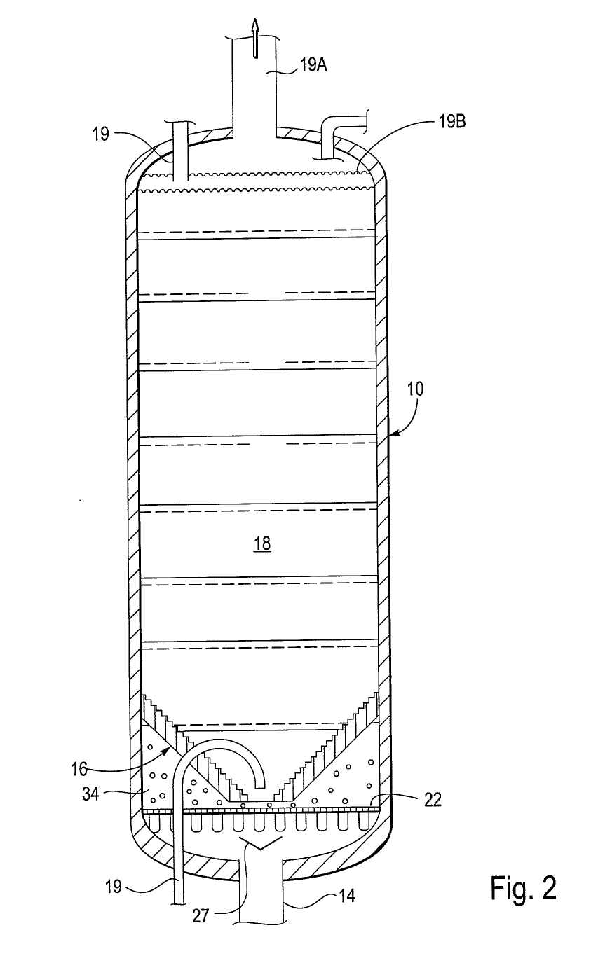

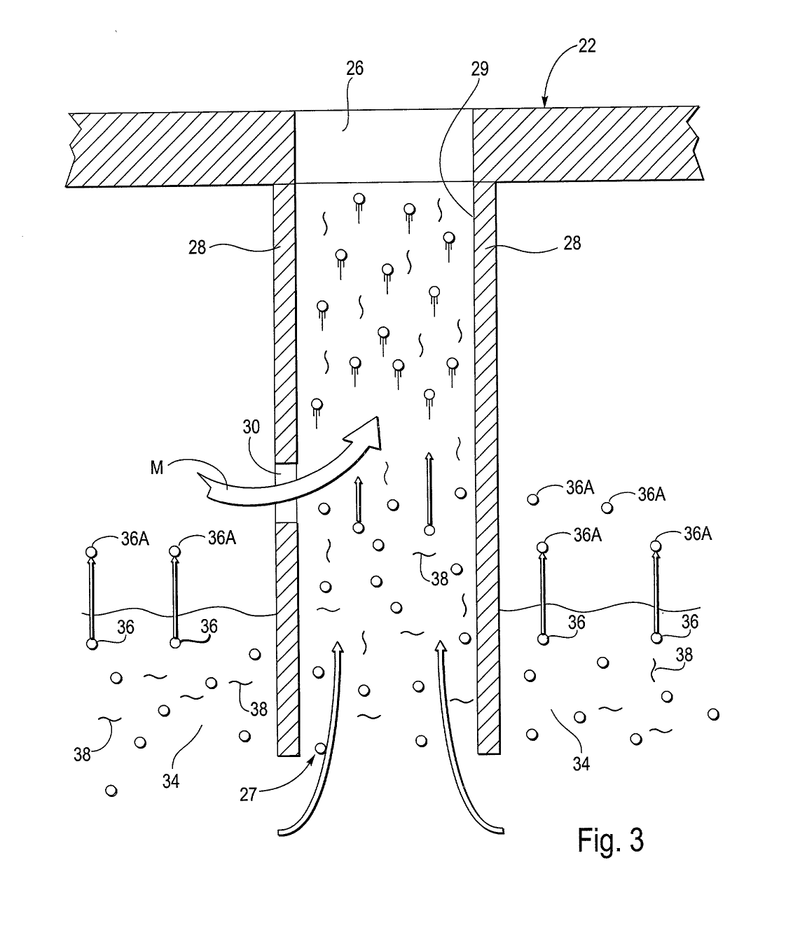

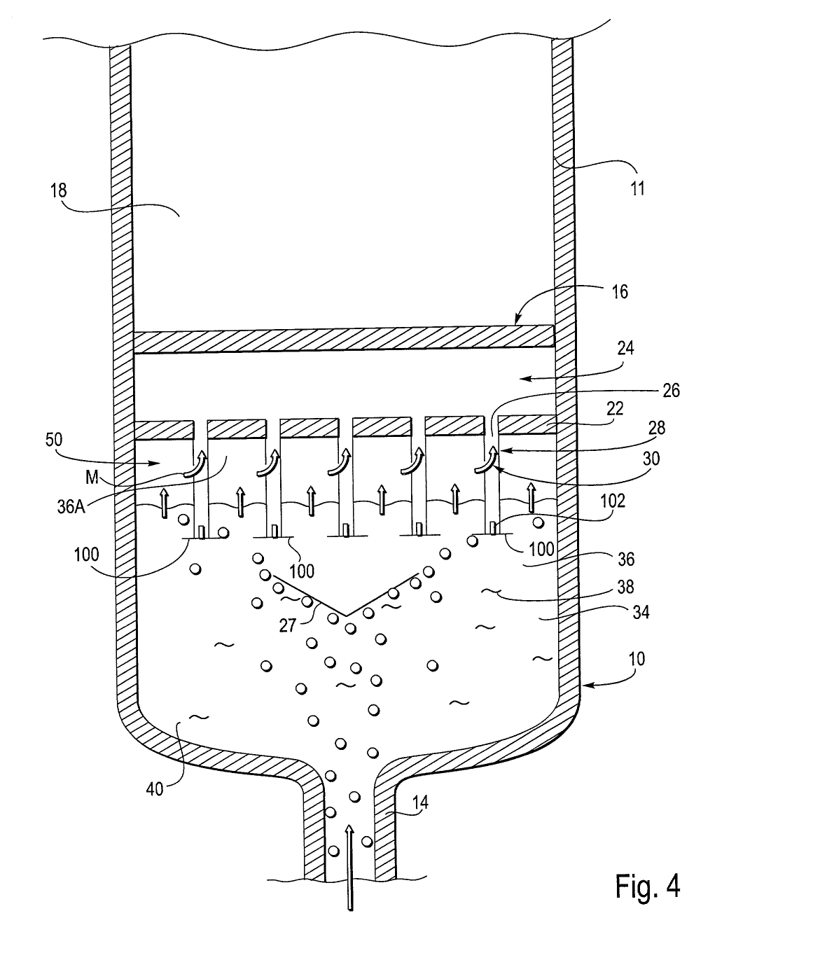

We now refer in detail to FIG. 4, which depicts a reactor. Parts of the invention similar to those of the previously described reactors (FIGS. 1-3) are identified by like reference numerals. The reactor includes a vessel 10 designed to react a hydrogen-containing gas 36 mixed with a liquid hydrocarbon stream 38 at a pressure of up to about 300 atmospheres (about 4500 lbs. per square inch) and up to about 650° C. (about 1200° F.). For such reaction, hydrogen-containing gas 36 and liquid hydrocarbon stream 38 are preferably premixed and introduced as a single stream (i.e., a single two-phase flow) through a conduit 14 having a concentric disposition with respect to the reactor vessel 10.

The reactor vessel 10 contains a catalyst bed support means, generally illustrated as 16, for supporting a catalyst bed 18 and containing appropriate openings (not shown) well known to the artisans in the art. The catalyst bed support means 16 contained in the reactor vessel 10 may be of any suitable geometric shape, such as concentric rings, conical, pyramidal, truncated polygonal or conical, frusto-conical, etc. The catalyst bed support means 16 further may be of any type that preferably insures even and equal distribution of hydrogen-containing gas 36 and liquid hydrocarbon stream 38 across a full cross-sectional area of the catalyst bed 18.

To assure maximum catalytic benefit during the hydroprocessing of the hydrogen-containing gas 36 and the liquid hydrocarbon stream 38, it is preferred that the reactor vessel 10 contain as much catalyst as possible within the design volume of the reactor vessel 10. Accordingly, it is preferred that the catalyst bed support means 16 for the catalyst bed 18 be placed as low as possible in the reactor vessel 10 while assuring full and adequate dispersion of the hydrogen-containing gas 36 within the liquid hydrocarbon stream 38.

The upper level of the catalyst bed 18 is to be controlled such that ebullation, expansion, or fluidization of the catalyst bed 18 is minimized and that undesirable excursions from the design flow rate for hydrogen-containing gas 36 and liquid hydrocarbon stream 38 flowing upwardly through the catalyst bed 18 are avoided for the selected catalyst. U.S. Pat. No. 5,472,928, issued Dec. 5, 1995, which is fully incorporated herein by reference, discusses control of catalyst bed level in more detail. The size, shape, and density of the catalyst particles within the catalyst bed 18 are to be essentially uniform and are selected in accordance with the designed maximum rate of flow of feed streams or a mixture 34 of the hydrogen-containing gas 36 and the liquid hydrocarbon stream 38 to prevent ebullation, expansion, or fluidization of the catalyst bed 18 while the latter progressively moves down through the reactor vessel 10 in layers by plug flow.

The reactor vessel 10 also contains a generally circular plate member 22 (i.e., a distributor tray), that is secured to an internal generally cylindrical wall 11 of the vessel such that a plenum chamber or vapor space 24 is produced between the catalyst bed support means 16 and the generally circular plate member 22. The distance between the level of the mixture 34 and the plate member 22 defines a static head wherein a suitable gas head 50 comprises evolved hydrogen-containing gas 36A that has originated from the mixture 34 of the hydrogen-containing gas 36 and the liquid hydrocarbon stream 38.

As was previously mentioned, the term “evolved hydrogen-containing gas” comprises: the hydrogen-containing gas 36 that is being introduced into the reactor vessel 10 along with the liquid hydrocarbon stream 38, any hydrogen gas that has evolved from the liquid hydrocarbon stream 38 itself, and hydrogen-containing gas 36 that solutionized and/or dissolved into and/or with the liquid hydrocarbon stream 38 and which has subsequently evolved from the liquid hydrocarbon stream 38, especially after introduction Into the reactor vessel 10.

The plate member 22 has a plurality of openings 26 that respectively communicate with a plurality of hollow risers 28 that are bound to the plate member 22. Stated alternatively, the plate member 22 includes a plurality of hollow risers 28 forming openings 26 through the plate member 22. At least one of the risers 28 (preferably all of them) contains at least one side opening 30 located intermediate its ends and above the mixture 34 (i.e., within the vapor space). Risers 28 may alternately be referred to as tube members and are so described in the claims.

The lengths of the respective hollow risers 28 may be selected such that the suitable gas head 50 is formed underneath the plate member 22 and/over the level of the mixture 34 to suppress surges in the feed stream(s) entering the bottom header 40 from the conduit 14. The hollow risers 28 receive the mixture 34 of hydrogen-containing gas 36 and liquid hydrocarbon stream 38 and pass the same through the openings 26 to enter the vapor space 24.

As the mixture 34 of the hydrogen-containing gas 36 and the liquid hydrocarbon stream 38 flows through the respective hollow risers 28, the evolved hydrogen-containing gas 36A within the static head (or the suitable gas head 50) enters or passes through the side openings 30. As the mixture 34 flows through conduit 14 and into a bottom header 40 disposed between the plate 22 and the bottom of the vessel, evolved hydrogen-containing gas 36A commences to evolve from the mixture 34 and the suitable gas head 50 begins to form. Continual flow of the mixture 34 into the bottom header 40 fills a volumetric portion of the bottom header 40 such as to produce the suitable gas head 50, all as best shown in FIG. 4.

The suitable gas head 50 has a pressure that is greater than the pressure of the mixture 34 such that with continual introduction of the mixture 34 into the bottom header 40, the mixture 34 commences to flow up and through each of the hollow risers 28 and out of the openings 26 and into the vapor space 24. When the suitable gas head 50 is formed and/or begins to form, evolved hydrogen-containing gas 36A commences to flow in direction of the arrows M through the side opening(s) 30 in the hollow risers 28; that is, evolved hydrogen-containing gas 36A commences to flow towards a lower pressure zone.

As the mixture 34 commences to flow up each of the hollow risers 28, some of the hydrogen-containing gas 36 evolves out of the mixture 34 such as to commingle with and/or admix with the evolved hydrogen-containing gas 36A entering through the openings 30 in the hollow risers 28.

The size of the openings 30 is carefully chosen to control the liquid level safely above the bottom of the riser 28 and also safely below the openings 30.

A deflector 27 is positioned above the inlet conduit 14 to help distribute the hydrogen gas bubbles across the cross sectional area of the vessel.

The features described above are also found in FIGS. 1-3. As previously noted, it has been found that despite the presence of the deflector 27, considerable quantities of hydrogen-containing gas manage to reach the more centrally located risers 28.

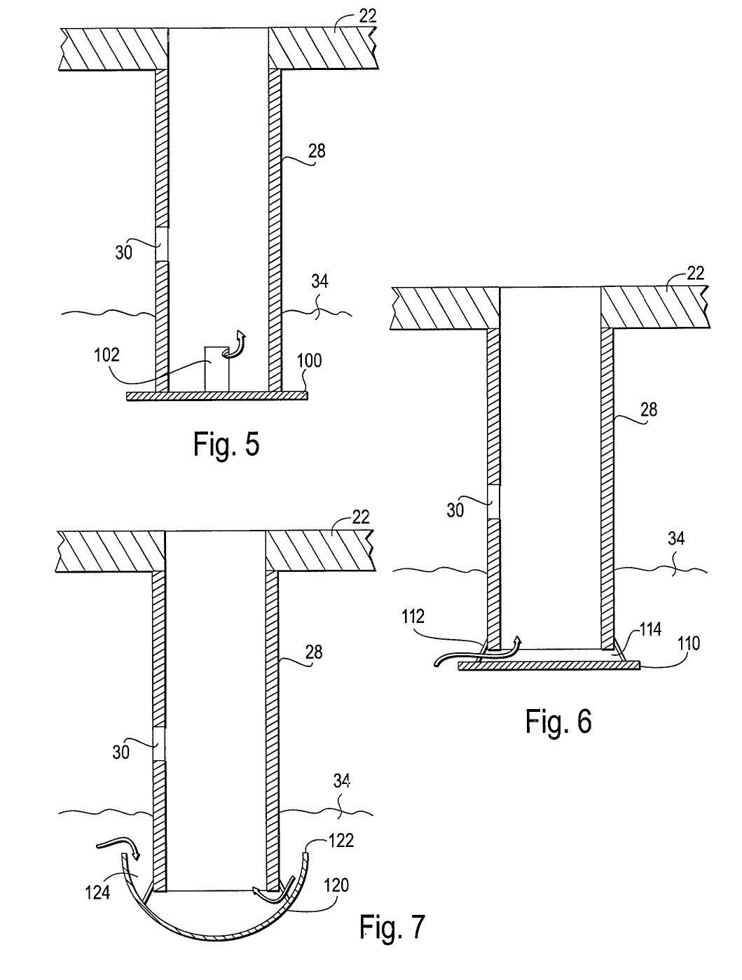

In accordance with the present invention, at least some, but possibly all, of the risers 28 are provided with an obstruction in the form of a cap 100 disposed across the bottom of the riser as shown in FIGS. 4 and 5. The cap constitutes a plate secured to the bottom of the riser and extending laterally therebeyond. Formed in each of the thus-obstructed risers is at least one, but preferably a plurality of openings 102 disposed below the level of mixture 34. Each opening 102 is shown as being in the form of a vertical slot which defines a lateral entrance into the riser. The openings 102 could have any suitable shape. It will be appreciated that the gas bubbles will not readily travel horizontally so as to be able to pass through the openings 102, especially since the portions of the cap 100 which project laterally beyond the riser tend to increase the lateral distance that the gas bubbles must flow in order to enter the riser. Accordingly, little gas will enter the obstructed risers at a location beneath the surface of mixture 34, enabling the openings 30 to perform the desired gas-metering function.

In an alternative embodiment of the invention shown in FIG. 6, the riser obstruction is in the form of a plate 110 spaced beneath the bottom of the riser. The plate 110 could be attached by brackets 112 to the riser, or situated on a perforated screen 112 (e.g., a conventional so-called Johnson screen) extending across the bottom header 40. The space 114 between the plate 110 and the bottom of the riser defines a lateral entrance to the obstructed riser.

The plate need not be flat. Instead, the plate 120 could be curved, as shown in FIG. 7, with the concave side thereof facing upwardly and spaced beneath the bottom of the riser. The outer edge 122 of the plate could be situated at a higher elevation than the bottom of the riser, requiring that any gas entering the riser travel not only laterally, but also downwardly, which makes it much more unlikely that gas bubbles can enter the riser through the lateral entrance 124 defined between the plate 120 and the riser bottom.

The obstruction 100, or 110 or 120 is preferably applied to the risers that are disposed in close relationship to the deflector 27, but if desired, all of the risers could be provided with obstructions. As a result of the obstructions, the hydrogen bubbles are distributed more uniformly across the bottom header, preventing a concentration of the bubbles at the center of the reactor.

While the present invention has been described herein with reference to particular embodiments thereof, a latitude of modification, various changes and substitutions are intended in the foregoing disclosure, and it will be appreciated that in some instances some features of the invention will be employed without a corresponding use of other features without departing from the scope of the invention as set forth.

What is claimed is:

1. A reactor comprising a vessel with an internal cylindrical wall and having a bottom domed closure which forms a bottom header, said domed closure having at least one inlet for introducing a mixture of hydrogen-containing gas and hydrocarbon liquid into the bottom header; a catalyst bed; a catalyst bed support means secured to said internal cylindrical wall of said vessel for supporting the catalyst bed; a plate member secured to the internal cylindrical wall of the vessel at a position below the catalyst bed support means and having a structure defining at least one opening; a mixture of a hydrogen-containing gas and a liquid hydrocarbon stream supported by the bottom domed closure and having a liquid level below the plate member; evolved hydrogen-containing gas between the liquid level and the plate member; at least one tube member having an obstructed bottom end in order to prevent entry of gas bubbles, and a tubular bore, said tube member being bound to said plate member such that said tubular bore communicates with said at least one opening; and said at least one tube member including at least one tubular opening in a side thereof, wherein the liquid level is above the bottom end of the at least one tube member and below the at least one tubular opening in the at least one tube member.

2. The reactor of claim 1, wherein the bottom end of the obstructed tube member is blocked by an obstruction extending across it.

3. The reactor of claim 2, wherein the obstruction completely blocks the bottom end of the obstructed tube member.

4. The reactor of claim 1, wherein said tube member has a tubular axis and said at least one tubular opening has an opening axis that is generally normal to said tubular axis.

5. The reactor of claim 1, wherein a deflector plate is disposed over the inlet in the bottomed domed closure in order to disperse gas bubbles outwardly in a lateral fashion.

6. The reactor according to claim 3, wherein an outer periphery of the obstruction is disposed below the bottom end of the obstructed tube member.

7. The reactor according to claim 1, wherein an outer periphery of the obstruction extends laterally beyond the bottom end of the obstructed tube member.

8. The reactor according to claim 1, wherein the obstruction is connected to the obstructed tube member.

9. The reactor according to claim 1, wherein the outer periphery of the obstruction extends higher than the bottom end of the obstructed tube member and is spaced laterally outwardly from the obstructed tube member, the lateral entrance being formed between the obstruction and the outer end of the obstructed tube member.

10. The reactor according to claim 9, wherein the obstruction comprises a curved plate having a concave side thereof facing upwardly.

11. The reactor according to claim 1, wherein all of the tube members constitute obstructed tube members.

12. A method for mixing a liquid hydrocarbon with a hydrogen-containing gas in a reactor, the method comprising the steps of:
(a) passing hydrogen-containing gas and liquid hydrocarbon into a reactor comprising a vessel with an internal cylindrical wall the vessel including an inlet spaced below the plate whereby a bottom header is formed beneath the plate; a catalyst bed support means secured to the internal cylindrical wall of the vessel; a plate member secured to the internal cylindrical wall of the vessel and having a structure defining at least one opening; at least one tube member having a tubular bore and bound to the plate member such that the tubular bore communicates with the at least one opening; and the at least one tube member including at least one tubular opening in a side thereof and an obstructed bottom end, thereby constraining the mixture to travel laterally to enter the obstructed risers from the bottom header;
(b) forming a liquid level of the liquid hydrocarbon below the plate member and an evolved hydrogen-containing gas between the liquid level and the plate member;
(c) passing at least a portion of the hydrogen-containing gas through the tubular side opening for mixing with the liquid hydrocarbon in the tubular bore of the tube member; and
(d) passing the mixture of liquid hydrocarbon and hydrogen-containing gas from the tubular bore of the tube member through the at least one opening in the plate member.

13. A method of hydroprocessing a hydrocarbon feed stream that is flowing through a hydroconversion reaction zone, comprising:
(a) mixing a liquid hydrocarbon with a hydrogen-containing gas in a reactor which contains a catalyst bed supported on a catalyst bed support means according to the method of claim 12; and
(b) passing the mixture of liquid hydrocarbon and hydrogen-containing gas into the catalyst bed supported on the catalyst bed support means.

14. The reactor according to claim 1, wherein the lateral entrance is disposed between the obstruction and the bottom end of the obstructed riser.
